(19) United States
(12) Patent Application Publication
(10) Pub. No.: US 2009/0160737 A1
(43) Pub. Date: Jun. 25, 2009

(54) Head mounted display apparatus

(75) Inventors: Spencer Wu, Taipei (TW); Ted Teng, Taipei (TW); Aaron Chen, Taipei (TW); Kevin Kao, Taipei (TW); Ian Liu, Taipei (TW)

Correspondence Address: ATTN: Juan Carlos A. Marquez;REED SMITH LLP, Suite 1400, 3110 Fairview Park Drive, Falls Church, VA, 22042, US

(73) Assignee: Oculon Optoelectronics, Inc.

(21) Appl. No.: 12/003,370

(22) Filed: Dec. 21, 2007

(51) Int. Cl. G09G 5/00

(52) U.S. Cl. 345/8

(57) ABSTRACT

A head-mounted display apparatus for a first external video source and a second external video source includes a support, an optical unit, a receiver, and a micro controller. The support is to be worn on a user's head. The optical unit displays video for the user. The receiver selectively receives video signals provided from the first external video source or the second external video source. The micro controller is electrically connected to the receiver for processing the signal to control the optical unit to display the video.

### FIELD OF THE INVENTION

The present invention relates to a head-mounted display apparatus and, particularly, the head-mounted display apparatus for presenting video from one of external video sources selectively.

### BACKGROUND OF THE INVENTION

Conventionally, computers or television sets include cathode ray tube (CRT) displays, liquid crystal displays (LCD), or electroluminescence displays, for example. Nevertheless, those conventional display apparatuses for computers or TVs have some problems. On one hand, the cathode ray tube (CRT) displays are heavy and thick. On the other hand, the liquid crystal display (LCD) of the mobile devices is portable for users, but it's uncomfortable for users to use in such compact sizes. Therefore, with the advantages of the compact size and the light weight and the perceivably-large video output, head-mounted displays have become popular and their use has been widespread.

Besides, the conventional portable display is designed to display image/video from some limited sources embedded inside the apparatus. However, if a portable head-mounted display adapts all functions, such as digital TV, DVD payer, MP4, mobile device etc., in the conventional manner, the firmware implementation becomes excessively complicated and the portability, durability and manufacturability of the digital video player will be sacrificed.

Therefore, it would be desirable to have a head mounted display apparatus for optionally being connected with a variety of removable and changeable source devices according to the need of the users. The users can also display the data from several sources, such as digital TV, DVD payer, MP4, mobile device, etc., in large-screen effect. In particular, the head-mounted display apparatus is capable of being connected with different removable modules for switching between and displaying data from different sources. Therefore, it would be desirable to have a head mounted display to connect with various removable source devices depending on the users' option. The users can also display the data from several sources, such as digital TV, DVD payer, MP4, mobile device, etc., in large-screen effect. In particular, the head-mounted display apparatus is capable of being connected with different removable modules for switching between and displaying data from different sources.

### SUMMARY OF THE INVENTION

The present invention overcomes the deficiencies and limitations of conventional head-mounted display apparatus by providing a novel head-mounted display apparatus having an extension unit to connect with external video sources. The extension unit is optionally connected to a variety of source devices according to the need of the users. The present invention includes a head-mounted display having a receiver for a plurality of external video sources. For example, the external video sources are insertable computer cards, each performing different functions. The external video sources are connected with the extension unit, which are removable.

In one embodiment, a head-mounted display apparatus for a first external video source and a second external video source includes a support, an optical unit, a receiver, and a micro controller. The support is to be worn on a user's head. The optical unit displays video for the user. The receiver receives video signals selectively provided by the first external video source or the second external video source. The micro controller is electrically connected to the receiver, for processing the signal to control the optical unit to display the video.

In another embodiment, the head-mounted display apparatus includes a switch connected to the receiver, wherein the receiver selects video signals provided from the first external video source or the second external video source according to a switch signal provided by the switch. The micro controller processes the signals further according to the switch signal.

In yet another embodiment, the first external video source and the second external video source are insertable computer cards, and for the insertable computer cards, the head-mounted display apparatus further includes a computer card adapter connected to the receiver. For example, the computer cards are PCMCIA cards. The first external video source or the second external video source is provided to supply signals of DVB-T/H, MP4, 1-Seg, RF Tx/Rx, DVD, or AV IN/OUT.

In still another embodiment, the first external video source is a mobile device, and the second external video source is a computer. The first external video source or the second external video source is connected to the receiver via a USB interface. In another embodiment, the first external video source or the second external video source is connected to the receiver via wireless.

The foregoing and other features of the invention will be apparent from the following more detailed description of embodiment of the invention.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a perspective diagram of the head-mounted display apparatus according to one embodiment of the present invention;

FIG. 1B is a schematic block diagram illustrating a head-mounted display apparatus according to one embodiment of the present invention; and

FIG. 1C is a schematic diagram illustrating an optical unit according to one embodiment of the present invention.

### DETAILED DESCRIPTION OF THE INVENTION

As follows, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of present invention. Benefits, other advantages, and solutions to problems have been described above with regard to specific embodiments.

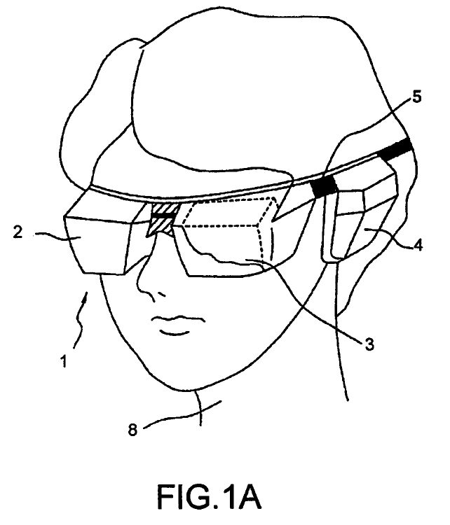

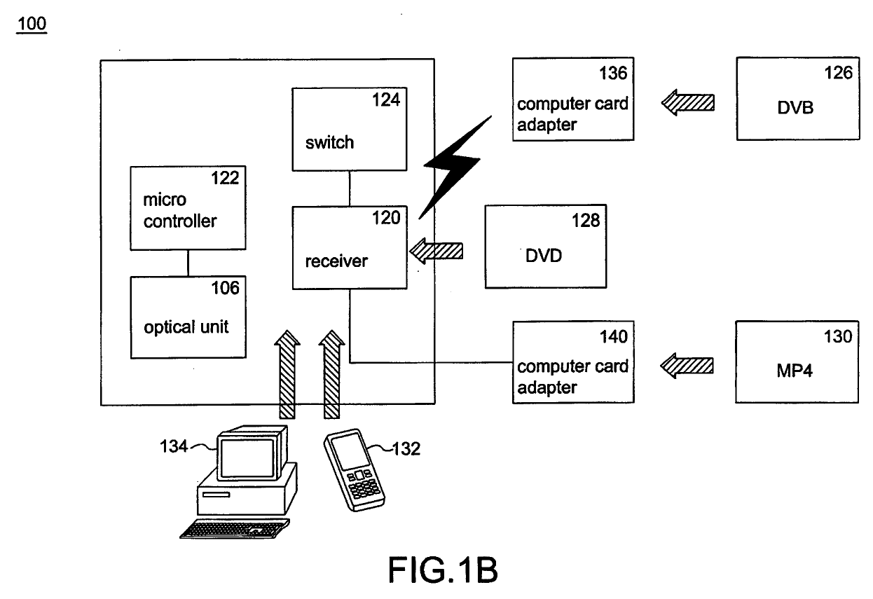

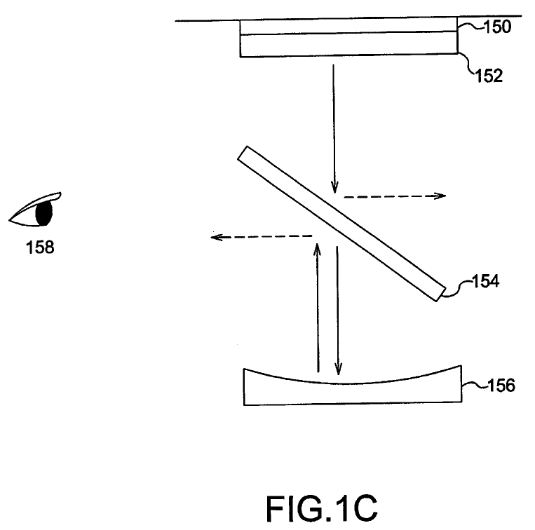

The present invention discloses a head-mounted display apparatus with an extender unit. The extender unit is optionally connected to a plurality of removable and changeable source devices in accordance with the need of the users. Therefore, the head-mounted display is able to display video data not only from a specific video source but also other removable sources. Please refer to the following descriptions in conjunction with the accompanying drawings, FIGS. 1A, 1B, and 1C.

FIG. 1A is a perspective diagram of the head-mounted display apparatus 100 according to one embodiment of the present invention. In this embodiment, the head-mounted display apparatus 100 includes the display chambers 108 intended for the right eye and the left eye respectively, thought its alternative design may have one single display chamber 108 intended for users who move about during work time. An optical unit 106, which creates images, is installed in each display chamber 108. With both eyes close to the display chambers 108, a user 110 browses various pictures displayed by the head-mounted display 100. In addition to the display chamber 108, the support 102 of the head-mounted display 100 is to be worn on user's head and may be equipped with an earpiece 104 to make the head-mounted display more useful.

FIG. 1B is a schematic block diagram illustrating a head-mounted display apparatus 100 shown in FIG. 1A. A head-mounted display apparatus 100 is provided for a first external video source 126 and a second external video source 128 and further includes a receiver 120, a switch 124, and a micro controller 122. The receiver 120 selectively receives video signals provided by the first external video source 126 or the second external video source 130. The micro controller 122 is electrically connected to the receiver 120, for processing the received signals to control the optical unit 106 to display the video. The switch 124 is connected to the receiver 120. The receiver 120 selects video signals provided from the first external video source 126 or the second external video source 128 according to a switch signal provided by the switch 124. The micro controller 122 processes the signals according to the switch signal.

In this embodiment, the first external video source 126 is an insertable computer card, like a DVB card, and the second external video source 128 is a media player. For the insertable computer card 126, the head-mounted display 100 includes a computer card adapter 136 connected to the receiver 120. The first external video source 126 is inserted into the computer card adapter 136. Meanwhile, the media player 128 can be also connected to the receiver 120. The media player 128 is directly connected to the adapter of the receiver 120 without the computer card adapter, for example, via wireless connection or a USB interface. The wireless connection may be implemented by Bluetooth, infrared, near field communication, and radio frequency (RF). In addition, those skilled in art should appreciate that the media player 128 may be a DVD player, a MP4 player, an iPOD of Apple or a PS2 of SONY. Note that the second external video source 128 can be a standalone media player capable of providing multimedia signals not only with the head-mounted display apparatus 100 but also with TVs or computer displays (not shown).

In other embodiments, the first external video source 126 or the second external video source 128 is provided to supply signals of DVB-T/H, MP4, 1-Seg, RF Tx/Rx, DVD, AV IN/OUT, or an IR camera.

Note that the DVB is a suite of internationally accepted open standards for digital television. Furthermore, the DVB-T standard is for Handheld and DVB-H standard is for Terrestrial. The MP4 is a standard used primarily to compress audio and visual (AV) digital data. The 1-Seg is a mobile terrestrial digital audio/video and data broadcasting service in Japan.

In another embodiment, the first external video source 126 or the second external video source 128 is an Infrared (IR) camera having an IR LED and a CCD. The IR LED is an electroluminescent (EL) device for emitting IR with wavelength in the range of 830 nm-1100 nm. The CCD receives the IR reflected from the IR-illuminated objects, and transforms the received IR into image signals and sends to the head-mounted display apparatus 100.

Also note that the computer card 126 may be formed as, but not limited to, a PCMCIA card. In computing, the PCMCIA is the form factor of a peripheral interface designed for laptop computers. It was originally for memory expansion, but the existence of a usable general standard for notebook peripherals led to many kinds of devices being made available in this form. In addition, those skilled in art should appreciate that the computer card 126 may be DVB-T/H computer card, MP4 computer card, 1-Seg computer card, RF TX/RX computer card, DVD computer card, AV IN/OUT computer card, etc.

In another embodiment, the first external video source 126 and the second external video source 130 are computer cards. The DVB card 126 and the MP4 card 130 are separately inserted into the computer card adapters 136 and 140. Moreover, the computer card adapter 136 is connected to the receiver 120 via wireless. The wireless may be implemented by Bluetooth, infrared, near field communication, and radio frequency (RF). However, the computer card adapter 140 is connected to the receiver 120 via a USB interface, as shown in FIG. 1B.

In yet another embodiment, the computer card adapter 136 is an extensible adapter. The user 110 may insert several kinds of computer cards 126 having different functions, such as MP4, DVB-T/H, 1-seg, RF Tx/Rx, DVD or AV IN/OUT, into the computer card adapter 136 according to the need of the user 100. The computer card adapter 136 is connected to the receiver 120 via wireless, as shown in FIG. 1B. The wireless connection may be implemented by Bluetooth, infrared, near field communication, and radio frequency (RF).

In still another embodiment, the first external video source is a mobile device 132, and the second external video source is a computer 134. In addition, those skilled in art should appreciate that the receiver 120 may be connected to a plurality of external video sources, not limited to the embodiment, two external video sources.

In another embodiment (now shown), both the first external video source and the second external video source have the same connectors to be connected with the adapter of the receiver 120. Preferably, the connectors of the first external video source and the second external video source are unique to the receiver 120.

As shown in FIG. 1B, the user 110 uses the switch 124 to select one among several video sources 126, 128, 130, 132, and 134. The receiver 120 selects video signals provided from video sources 126, 128, 130, 132, and 134 according to a switch signal provided by the switch 124. Then the micro controller 122 processes the video signals according to the switch signals of the switch 124. In one embodiment, if the video source is switched to the first external video source 126, then the micro controller 122 processed the DVB signals and transmits the processed signals to the optical unit 106 to display the image/video data.

FIG. 1C is a schematic diagram illustrating an optical unit 106 according to one embodiment of the present invention. The optical unit 106 includes a light source 150, a panel 152, a concave mirror 156, and a beam splitter 154. The light source 150 provides beams to the panel 152. The panel 152 modulates the beams provided from the light source 150 to form images of the video. The beam splitter 154 directs the beams to the concave mirror 156 for magnifying the images: The magnified images are projected back onto the beam splitter 154. Then the beam splitter 154 reflects/refracts the magnified images from the concave mirror 156.

In one embodiment, the optical unit 106 is connected to the micro controller 122. The optical unit 106 receives the signals processed by the micro controller 122. The light source 150 provides beams to the panel 152. The panel 152 modulates the beams to form images of the video. Then the beam splitter 154 directs the beams to the concave mirror 156 for magnifying the images. The magnified images are projected back onto the beam splitter 154. The beam splitter 154 reflects/refracts the magnified images from the concave mirror 156. Then the magnified images are watched by the eyes 158 of the user 110. The panel 152 includes a liquid crystal panel, or a LCoS panel. A coated film is formed on a surface of the beam splitter 154. The concave mirror 156 is a non-spherical concave mirror.

In one embodiment, the optical unit 106 is connected to the micro controller 122. The optical unit 106 receives the signals processed by the micro controller 122. The panel 152 provides beams itself to form images of the video without light source 150. The beam splitter 154 directs the beams to the concave mirror 156 for magnifying the images. The magnified images are projected back onto the beam splitter 154. Then the beam splitter 154 reflects/refracts the magnified images from the concave mirror 156. Then the magnified images are watched by the eyes 158 of the user 110. The panel 152 includes an organic light emitting device.

Although specific embodiments have been illustrated and described, it will be obvious to those skilled in the art that various modifications may be made without departing from what is intended to be limited solely by the appended claims.

What is claimed is:

1. A head-mounted display apparatus for a first external video source and a second external video source comprising:
a support to be worn on a user's head;
an optical unit for displaying video for said user;
a receiver for selectively receiving video signals provided from said first external video source or said second external video source; and
a micro controller electrically connected to said receiver, for processing said signal to control said optical unit to display said video.

2. The apparatus of claim 1, further comprising a switch connected to said receiver; wherein said receiver selects video signals provided from said first external video source or said second external video source according to a switch signal provided by said switch.

3. The apparatus of claim 2, wherein said micro controller processes said signals further according to said switch signal.

4. The apparatus of claim 1, wherein said first external video source and said second external video source are insertable computer cards, and for said insertable computer cards, said head-mounted display apparatus further comprises a computer card adapter connected to said receiver.

5. The apparatus of claim 4, wherein said computer cards are PCMCIA cards.

6. The apparatus of claim 1, wherein said first external video source or said second external video source is provided to supply signals of DVB-T/H, MP4, 1-Seg, RF Tx/Rx, DVD, AV IN/OUT, or an IR camera.

7. The apparatus of claim 1, wherein said first external video source is a mobile device, and5 said second external video source is a computer.

8. The apparatus of claim 1, wherein said first external video source or said second external video source is connected to said receiver via a USB interface.

9. The apparatus of claim 1, wherein said first external video source or said second external video source is connected to said receiver via wireless.

10. The apparatus of claim 1, wherein said optical unit comprises:
a light source for providing beams;
a panel for modulating said beams to form images of said video;
a concave mirror; and
a beam splitter for directing said beams to said concave mirror for magnifying said images;
wherein said magnified images are projected back onto said beam splitter, and said beam splitter reflects/refracts said magnified images from said concave mirror.

11. The apparatus of claim 10, wherein said panel comprises a liquid crystal panel, or a LCoS panel.

12. The apparatus of claim 10, wherein a coated film is formed on a surface of said beam splitter.

13. The apparatus of claim 10, wherein said concave mirror is a non-spherical concave mirror.

14. The apparatus of claim 1, wherein said optical unit comprises:
a panel for providing beams to form images of said video;
a concave mirror; and
a beam splitter for directing said beams to said concave mirror for magnifying said images;
wherein said magnified images are projected back onto said beam splitter, and said beam splitter reflects/refracts said magnified images from said concave mirror.

15. The apparatus of claim 14, wherein said panel comprises an organic light emitting device.

16. The apparatus of claim 14, wherein a coated film is formed on a surface of said beam splitter.

17. The apparatus of claim 14, wherein said concave mirror is a non-spherical concave mirror.

18. The apparatus of claim 1, wherein both said first external video source and said second external video source have the same connectors to be connected with an adapter of said receiver, and said connectors are unique to said adapter of said receiver.
